(19) United States
(12) Patent Application Publication
(10) Pub. No.: US 2026/0086659 A1
(43) Pub. Date: Mar. 26, 2026

(54) STYLUS PEN

(71) Applicant: Chicony Electronics Co., Ltd., New Taipei City (TW)

(72) Inventors: Chien-Shuo Chen, New Taipei City (TW); Mitsuo Horiuchi, New Taipei City (TW)

(21) Appl. No.: 19/265,153

(22) Filed: Jul. 10, 2025

(30) Foreign Application Priority Data
Sep. 26, 2024 (TW) 113136771

(51) Int. Cl. G06F 3/0354

(52) U.S. Cl. CPC G06F 3/03545

(57) ABSTRACT

A stylus pen includes a hollow pen tube, a pen head, a cantilever plate, a first strain electrode, and a second strain electrode. The pen head is at an open end of the hollow pen tube. The cantilever plate is disposed in the hollow pen tube, and the cantilever plate has a fixed side, a free side, a first surface, and a second surface. The fixed side is fixed to the hollow pen tube, and the first surface faces the open end. The first strain electrode is disposed on the first surface of the cantilever plate. The second strain electrode is disposed on the second surface of the cantilever plate. The pen head is movable with respect to the hollow pen tube to deform the cantilever plate, thereby deforming the first strain electrode and the second strain electrode correspondingly.

### CROSS-REFERENCE TO RELATED APPLICATION

This non-provisional application claims priority under 35 U.S.C. § 119(a) to Patent Application No. 113136771 filed in Taiwan, R.O.C. on Sep. 26, 2024, the entire contents of which are hereby incorporated by reference.

### BACKGROUND

### Technical Field

The instant disclosure relates to an electronic device, in particular, to a stylus pen.

### Related Art

Along with the rapid developments of technology, touch panels are widely utilized as the operating interfaces for various electronic devices (such as smartphones and tablet computers), so that a user can perform the operation of the electronic device through touching thereby improving operation convenience of the electronic device. However, to make the process of operating the touch panel faster and more accurate, the user often chooses to use a stylus pen for touch input (for example, writing or tapping).

### SUMMARY

In general, a stylus pen known to the inventor includes a force sensor in the pen housing. When the user operates the stylus pen to contact the touch panel, the pen nib of the stylus pen can press against the force sensor to perform the touch operation. However, because the touch operation is triggered through the force sensor, the user needs to apply a greater force to trigger the touch operation properly, and a certain trigger stroke is needed between the force sensor and the pen nib. As a result, upon the operation of the pen nib, wobbling of the pen nib occurs easily to affect the operation feeling of the stylus pen.

In view of this, in one embodiment, a stylus pen is provided. The stylus pen comprises a hollow pen tube, a pen head, a cantilever plate, a first strain electrode, and a second strain electrode. The hollow pen tube has an open end. The pen head is at the open end. The cantilever plate is disposed in the hollow pen tube, and the cantilever plate has a fixed side, a free side, and a first surface and a second surface which are opposite to each other. The fixed side is fixed to the hollow pen tube, and the first surface faces the open end. The first strain electrode is disposed on the first surface of the cantilever plate. The second strain electrode is disposed on the second surface of the cantilever plate. The pen head is movable with respect to the hollow pen tube to deform the cantilever plate, thereby deforming the first strain electrode and the second strain electrode correspondingly.

As above, according to the stylus pen of one or some embodiments of the instant disclosure, the pen head is movable with respect to the hollow pen tube to drive the cantilever plate to be deformed, thereby allowing the strain electrodes to be deformed correspondingly to generate touch signals. Therefore, the force the user applying to the stylus pen can be greatly reduced and wobbling of the pen head of the stylus pen can be prevented, thereby allowing the stylus pen to provide a better operation feeling for the user. Moreover, according to the stylus pen of one or some embodiments of the instant disclosure, the first strain electrode and the second strain electrode are respectively disposed on the first surface and the second surface opposite to each other of the cantilever plate. When the first strain electrode and the second strain electrode are deformed, a greater change in resistance difference can be generated, so that the sensing sensitivity can be enhanced and the circuit design can be simplified.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of a stylus pen according to a first embodiment of the instant disclosure;

FIG. 2 illustrates an exploded view of the stylus pen of the first embodiment;

FIG. 3 illustrates a partial perspective view of the stylus pen of the first embodiment;

FIG. 4 illustrates a cross-sectional view of the stylus pen of the first embodiment;

FIG. 5 illustrates a schematic operation view of the stylus pen of the first embodiment;

FIG. 6 illustrates a circuit diagram of the stylus pen of the first embodiment;

FIG. 7 illustrates a partial plan view of a stylus pen according to a second embodiment of the instant disclosure;

FIG. 8 illustrates a circuit diagram of the stylus pen of the second embodiment;

FIG. 9 illustrates a partial perspective view of a stylus pen according to a third embodiment of the instant disclosure;

FIG. 10 illustrates a partial perspective view of a stylus pen according to a fourth embodiment of the instant disclosure;

FIG. 11 illustrates a partial perspective view of a stylus pen according to a fifth embodiment of the instant disclosure;

FIG. 12 illustrates a partial perspective view of a stylus pen according to a sixth embodiment of the instant disclosure; and

FIG. 13 illustrates a partial perspective view of a stylus pen according to a seventh embodiment of the instant disclosure.

### DETAILED DESCRIPTION

It should be noted that, in the descriptions for the embodiments, the ordinal numbers, e.g., “first”, “second”, “third”, and “fourth” are respectively used to describe different elements, and these elements are not limited due to the use of these ordinal numbers. Furthermore, for the sake of convenience and clarity, the thickness or size of each component in the drawings is exaggerated, omitted, or schematically expressed for the purpose of understanding and reading by persons having ordinary skills in the art, and the size of each component is not the actual size of the component and is not intended to limit the conditions under which the instant disclosure can be implemented, and thus the size of the component does not have substantive technical meaning. Moreover, it is understood that, any structural modifications, changes in proportions, or adjustments in size should still fall within the scope of the technical content disclosed in the instant disclosure without affecting the effects that can be produced and the purposes that can be achieved by the instant disclosure. Moreover, in all the drawings, the same reference numbers are used to indicate identical or similar elements.

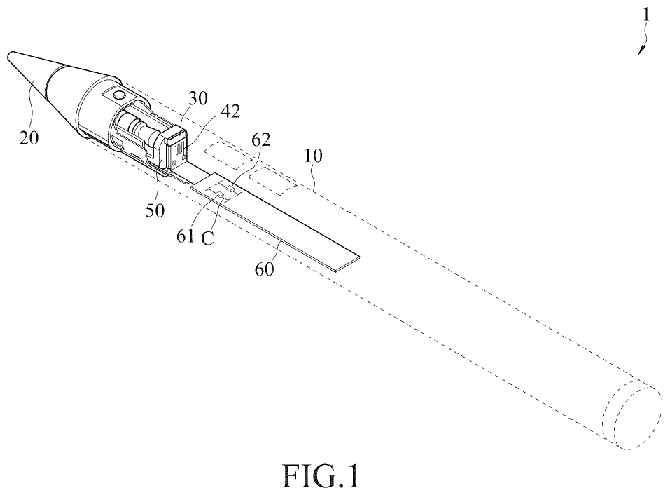

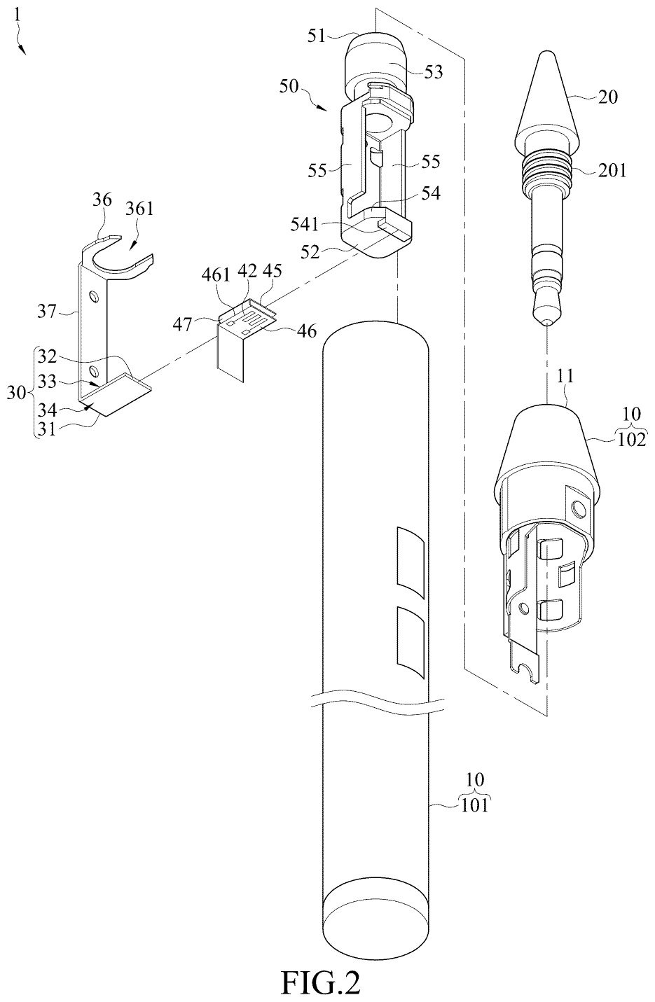

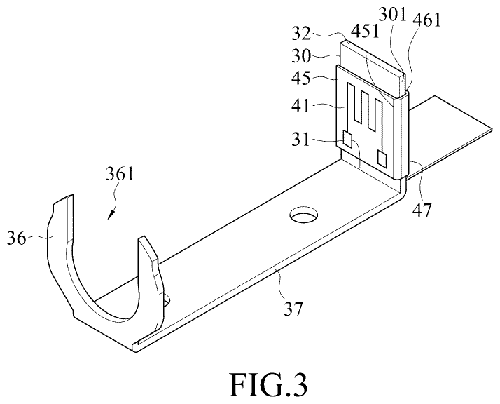

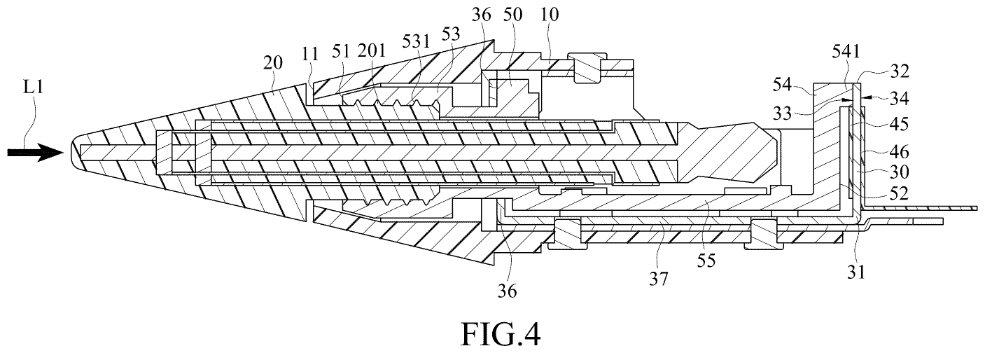

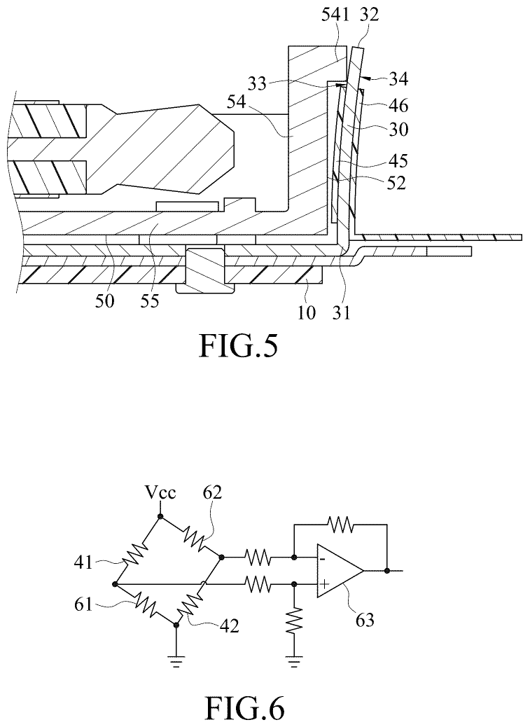

FIG. 1 illustrates a perspective view of a stylus pen according to a first embodiment of the instant disclosure. FIG. 2 illustrates an exploded view of the stylus pen of the first embodiment. FIG. 3 illustrates a partial perspective view of the stylus pen of the first embodiment. FIG. 4 illustrates a cross-sectional view of the stylus pen of the first embodiment. FIG. 5 illustrates a schematic operation view of the stylus pen of the first embodiment. As shown in FIG. 1 to FIG. 5, in this embodiment, the stylus pen 1 comprises a hollow pen tube 10, a pen head 20, a cantilever plate 30, a first strain electrode 41, and a second strain electrode 42.

As shown in FIG. 1 and FIG. 2, the hollow pen tube 10 has an open end 11. In this embodiment, the hollow pen tube 10 has a pen body tube portion 101 and a pen head tube portion 102, one of two ends of the pen head tube portion 102 is assembled on the pen body tube portion 101 (for example, the pen body tube portion 101 and the pen head tube portion 102 are assembled with each other through threading, engaging, or tightly-fitting), and the open end 11 is at the other end of the pen head tube portion 102. In some embodiments, the pen body tube portion 101 and the pen head tube portion 102 may be integrally connected to each other, so that the hollow pen tube 10 is formed as a one-piece structure.

As shown in FIG. 2 to FIG. 4, the pen head 20 is disposed at the open end 11 of the hollow pen tube 10 and movable with respect to the hollow pen tube 10. In this embodiment, the pen head 20 is connected to a linkage member 50, and the linkage member 50 is movably disposed in the hollow pen tube 10 and adjacent to the open end 11. The linkage member 50 has a first end 51 and a second end 52 which are opposite to each other. The first end 51 is nearer to the open end 11 as compared with the second end 52 (in other words, in this embodiment, the distance between the first end 51 and the open end 11 is less than the distance between the second end 52 and the open end 11). Moreover, the linkage member 50 is not fixed, so that the linkage member 50 can be moved along the extension direction of the hollow pen tube 10 when the linkage member 50 is subjected to a force.

As shown in FIG. 2 and FIG. 4, in this embodiment, the first end 51 of the linkage member 50 has a hollow post 53, one end of the pen head 20 located in the hollow pen tube 10 has a first thread portion 201, the hollow post 53 of the linkage member 50 has a second thread portion 531, and the first thread portion 201 of the pen head 20 and the second thread portion 531 of the linkage member 50 can be threadedly assembled with each other. Therefore, when the pen head 20 is forced to be moved toward the interior of the hollow pen tube 10 (as indicated by the arrow L1 shown in FIG. 4), the pen head 20 correspondingly drives the linkage member 50 to be moved with respect to the hollow pen tube 10. However, the embodiments are provided for illustrative purposes, and the instant disclosure is not limited thereto. In some embodiments, the pen head 20 and the linkage member 50 may be assembled with each other through other manners (such as engaging or tightly-fitting).

As shown in FIG. 2 to FIG. 4, the cantilever plate 30 is disposed in the hollow pen tube 10. The cantilever plate 30 has a fixed side 31, a free side 32, and a first surface 33 and a second surface 34 which are opposite to each other. The fixed side 31 of the cantilever plate 30 is fixed to the hollow pen tube 10, and the free side 32 of the cantilever plate 30 is not fixed. The first surface 33 and the second surface 34 are connected between the fixed side 31 and the free side 32, the first surface 33 faces the open end 11 of the hollow pen tube 10, and the second surface 34 faces away from the open end 11. Therefore, when the first surface 33 or the second surface 34 of the cantilever plate 30 is subjected to an external force, the cantilever plate 30 can swing or deform with respect to the hollow pen tube 10 by taking the fixed side 31 as the axis; when the force is removed, the cantilever plate 30 can return resiliently to the original state (in which the cantilever plate 30 is not swung and deformed yet).

As shown in FIG. 2 to FIG. 4, the first strain electrode 41 is disposed on the first surface 33 of the cantilever plate 30, and the second strain electrode 42 is disposed on the second surface 34 of the cantilever plate 30. The first strain electrode 41 and the second strain electrode 42 may be conductive wires made of metal materials (such as copper-nickel alloy, nickel-chrome alloy, or copper). For example, in this embodiment, the conductive wire is wound to form a metal wire sensing grid. When the cantilever plate 30 is deformed, the first strain electrode 41 and the second strain electrode 42 are deformed correspondingly, such that the conductive wire is stretched or compressed.

In some embodiments, the first strain electrode 41 and the second strain electrode 42 can be directly formed on the surfaces of the cantilever plate 30. For example, the first strain electrode 41 and the second strain electrode 42 may be respectively formed on the first surface 33 and the second surface 34 of the cantilever plate 30 through electroplating, etching, or the like. Alternatively, in some embodiments, the first strain electrode 41 and the second strain electrode 42 may be indirectly disposed on the first surface 33 and the second surface 34 of the cantilever plate 30, respectively, through substrates. For example, as shown in FIG. 2 and FIG. 4, in this embodiment, the first surface 33 of the cantilever plate 30 is provided with a first flexible sheet 45, the second surface 34 of the cantilever plate 30 is provided with a second flexible sheet 46. The first flexible sheet 45 and the second flexible sheet 46 may be made of flexible insulated materials (such as insulated plastics), and the first flexible sheet 45 and the second flexible sheet 46 may be respectively adhered on the first surface 33 and the second surface 34 of the cantilever plate 30 through adhesives. The first strain electrode 41 may be on the first flexible sheet 45, and the second strain electrode 42 may be on the second flexible sheet 46, so that the first strain electrode 41 and the second strain electrode 42 are indirectly disposed on the first surface 33 and the second surface 34 of the cantilever plate 30 respectively. Moreover, because of the flexibility of the first flexible sheet 45 and the second flexible sheet 46, when the cantilever plate 30 is deformed, the first strain electrode 41, the second strain electrode 42, the first flexible sheet 45, and the second flexible sheet 46 can be deformed correspondingly.

FIG. 5 illustrates a schematic operation view of the stylus pen of the first embodiment. As shown in FIG. 2 to FIG. 5, the linkage member 50 is positioned between the pen head 20 and the first surface 33 of the cantilever plate 30, and the second end 52 of the linkage member 50 contacts the first surface 33 of the cantilever plate 30. In this embodiment, the second end 52 of the linkage member 50 has a press plate 54, a surface of the press plate 54 facing the cantilever plate 30 has a protrusion 541, and the protrusion 541 contacts the first surface 33 of the cantilever plate 30. Moreover, the linkage member 50 further has a plurality of connection plates 55, and the connection plates 55 are integrally connected between the press plate 54 and the hollow post 53.

Accordingly, as shown in FIG. 2 to FIG. 5, when the user operates the stylus pen 1 to press the pen head 20 against the touch surface of an electronic device, the pen head 20 can be pressed to drive the linkage member 50 to be moved toward the cantilever plate 30 with respect to the hollow pen tube 10 (in the direction indicted by the arrow L1 shown in FIG. 4). Therefore, the second end 52 of the linkage member 50 pushes against the first surface 33 of the cantilever plate 30 to drive the cantilever plate 30 to be deformed. Hence, the first strain electrode 41 and the second strain electrode 42 are deformed correspondingly to generate changes in their resistances. Furthermore, the processor (not shown in the figures) of the stylus pen 1 is electrically connected to the first strain electrode 41 and the second strain electrode 42, and the processor can generate corresponding touch signals according to the changes in resistance.

Moreover, in the stylus pen 1 according to one or some embodiments of the instant disclosure, the first strain electrode 41 and the second strain electrode 42 are respectively disposed on the first surface 33 and the second surface 34 of the cantilever plate 30 which are opposite to each other. When the cantilever plate 30 is deformed to correspondingly drive the first strain electrode 41 and the second strain electrode 42 to be deformed, one of the first strain electrode 41 and the second strain electrode 42 is stretched, and the other one of the first strain electrode 41 and the second strain electrode 42 is compressed, so that the resistances of the first strain electrode 41 and the second strain electrode 42 change oppositely. In other words, in this embodiment, the resistance of one of the first strain electrode 41 and the second strain electrode 42 increases, and the resistance of the other one of the first strain electrode 41 and the second strain electrode 42 decreases. Consequently, a larger change in the resistance difference between the strain electrodes can be generated.

For example, as shown in FIG. 2 to FIG. 5, in this embodiment, when the cantilever plate 30 is pushed against by the linkage member 50, the cantilever plate 30 is moved away from the pen head 20 to be bent and/or deformed (as shown in FIG. 5). In the case that both the strain electrodes (the first strain electrode 41 and the second strain electrode 42) are disposed on the same surface (for example, the first surface 33 or the second surface 34) of the cantilever plate 30, both the first strain electrode 41 and the second strain electrode 42 will be stretched or compressed and the resistances of the strain electrodes simultaneously increase or decrease, so that the change in the resistance difference between the first strain electrode 41 and the second strain electrode 42 is negligible (i.e., the change in the resistance variation is small). On the other hand, according to one or some embodiments of the instant disclosure, the first strain electrode 41 and the second strain electrode 42 are respectively disposed on the first surface 33 and the second surface 34 of the cantilever plate 30. Therefore, when the cantilever plate 30 is bent and/or deformed, the first strain electrode 41 is stretched and the resistance of the first strain electrode 41 increases, while the second strain electrode 42 is compressed and the resistance of the second strain electrode 42 decreases. In other words, in this embodiment, the two resistances of the first strain electrode 41 and the second strain electrode 42 exhibit an inverse change, one positive and one negative. Consequently, as compared with the configuration that both strain electrodes are disposed on the same surface of the cantilever plate 30, upon deformation, the first strain electrode 41 and the second strain electrode 42 of the stylus pen 1 according to one or some embodiments of the instant disclosure generate a larger change in resistance difference (i.e., the resistance difference between the first strain electrode 41 and the second strain electrode 42 is larger). Accordingly, not only the sensing sensitivity can be enhanced but also the circuit design can be streamlined (for example, a noise filter circuit may not need to be provided for the stylus pen 1). Moreover, because of the enhancement of the sensing sensitivity, the force the user applying to the stylus pen 1 can be greatly reduced, and wobbling of the pen head 20 of the stylus pen 1 during the operation can be prevented, so that the stylus pen 1 can provide a better operation feeling.

FIG. 6 illustrates a circuit diagram of the stylus pen of the first embodiment. In some embodiments, the first strain electrode 41 and the second strain electrode 42 may be connected to an amplifier to further amplify the change in the resistance difference between the strain electrodes, thereby increasing the sensing accuracy. As shown in FIG. 1, FIG. 2, and FIG. 6, in this embodiment, the stylus pen 1 comprises a circuit board 60, and the circuit board 60 is disposed in the hollow pen tube 10. The circuit board 60 has a sensing circuit C, and the sensing circuit C has a first fixed resistor 61, a second fixed resistor 62, and an operational amplifier 63. The first strain electrode 41 and the first fixed resistor 61 are connected in series to form a first series connection circuit, the second strain electrode 42 and the second fixed resistor 62 are connected in series to form a second series connection circuit, and the first series connection circuit and the second series connection circuit are connected in parallel to form a Wheatstone bridge, so that the electrical connection between the first strain electrode 41 and the second strain electrode 42 are not in series. Moreover, the first series connection circuit and the second series connection circuit are respectively connected to two input terminals of the operational amplifier 63. Therefore, when the first strain electrode 41 and the second strain electrode 42 are deformed, the difference of the resistances between the two strain electrodes (i.e., the change in the resistance between the strain electrodes) can be further amplified through the operational amplifier 63, and the processor can generate corresponding touch signals according to the amplified information. Furthermore, in one or some embodiments, the connection positions of the first strain electrode 41 and the first fixed resistor 61 can be exchanged, and the connection positions of the second strain electrode 42 and the second fixed resistor 62 can be exchanged, so that a Wheatstone bridge can be formed as well, and the purpose of generating a larger change in the resistance difference between the strain electrodes can be achieved.

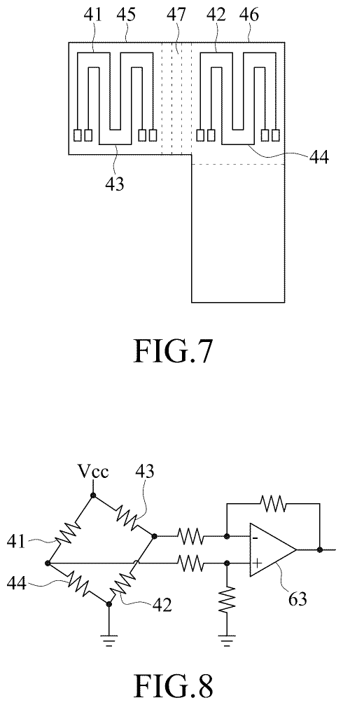

FIG. 7 illustrates a partial plan view of a stylus pen according to a second embodiment of the instant disclosure. As shown in FIG. 7, in another embodiment, the stylus pen 1 may further comprise a third strain electrode 43 and a fourth strain electrode 44. The third strain electrode 43 and the fourth strain electrode 44 may be conductive wires made of metal materials (such as copper-nickel alloy, nickel-chrome alloy, or copper). For example, in this embodiment, the conductive wire is wound to form a metal wire sensing grid. The third strain electrode 43 and the fourth strain electrode 44 may be respectively disposed on the first surface 33 and the second surface 34 of the cantilever plate 30. For example, in this embodiment, the first strain electrode 41 and the third strain electrode 43 are disposed on the first flexible sheet 45, and the second strain electrode 42 and the fourth strain electrode 44 are disposed on the second flexible sheet 46. Therefore, when the cantilever plate 30 is deformed, the first strain electrode 41, the second strain electrode 42, the third strain electrode 43, and the fourth strain electrode 44 are deformed correspondingly. For instance, both the first strain electrode 41 and the third strain electrode 43 are stretched to increase their resistances, and both the second strain electrode 42 and the fourth strain electrode 44 are compressed to decrease their resistances. Therefore, the difference between the sum of the resistances of the first strain electrode 41 and the third strain electrode 43 and the sum of the resistances of the second strain electrode 42 and the fourth strain electrode 44 is much larger (as compared with the configuration that the stylus pen 1 does not include the third strain electrode 43 and the fourth strain electrode 44), so that a much larger change in resistance differences between the strain electrodes can be generated to enhance the sensing sensitivity.

FIG. 8 illustrates a circuit diagram of the stylus pen of the second embodiment. In some embodiments, likewise, the first strain electrode 41, the second strain electrode 42, the third strain electrode 43, and the fourth strain electrode 44 can be connected to the amplifier to further amplify the change in the resistance difference between the strain electrodes, thereby enhancing the sensing accuracy. As shown in FIG. 8, in this embodiment, the first strain electrode 41 and the fourth strain electrode 44 are connected in series to form a first electrode group, the second strain electrode 42 and the third strain electrode 43 are connected in series to form a second electrode group, and the first electrode group and the second electrode group are connected in parallel to form a Wheatstone bridge. The electrical connection between the first strain electrode 41 and the second strain electrode 42 is not in series and the electrical connection between the third strain electrode 43 and the fourth strain electrode 44 is not in series. Moreover, the first electrode group and the second electrode group are respectively connected to two input terminals of the operational amplifier 63. Therefore, when the first strain electrode 41, the second strain electrode 42, the third strain electrode 43, and the fourth strain electrode 44 are deformed, the difference of the resistances (i.e., the change in the resistance difference) among the four strain electrodes can be further amplified through the operational amplifier 63, and the processor can generate corresponding touch signals according to the amplified information.

As shown in FIG. 5, in this embodiment, the protrusion 541 at the second end 52 of the linkage member 50 contacts the first surface 33 of the cantilever plate 30 and is adjacent to the free side 32. Therefore, when the pen head 20 is pressed to drive the linkage member 50 to push against the cantilever plate 30, the protrusion 541 pushes against the cantilever plate 30, and the cantilever plate 30 can be deformed more easily to generate a larger deformation extent. Therefore, the force required by the user during operation can be further reduced.

As shown in FIG. 2 and FIG. 4, in this embodiment, the stylus pen 1 further comprises a supporting plate 36. The supporting plate 36 is disposed in the hollow pen tube 10, and the supporting plate 36 is connected to the linkage member 60 and adjacent to the first end 51, so that the linkage member 50 can be supported by the supporting plate 36 and wobbling of the linkage member 50 during the operation can be prevented. In this embodiment, the supporting plate 36 is a U-shaped plate and has an open groove 361, and a region of the linkage member 50 adjacent to the first end 51 is accommodated in the open groove 361, so that the supporting plate 36 can be positioned more properly.

As shown in FIG. 2 and FIG. 4, the supporting plate 36 may be connected to the cantilever plate 30. In this embodiment, a fixed plate 37 is disposed in the hollow pen tube 10. For example, the fixed plate 37 may be fixed to an inner wall of the hollow pen tube 10 by means of threading, engaging, tightly-fitting, or the like. The fixed side 31 of the cantilever plate 30 is integrally connected to one of two ends of the fixed plate 37, so that the fixed side 31 is fixed in the hollow pen tube 10. The supporting plate 36 is integrally connected to the other end of the fixed plate 37, so that the supporting plate 36 and the cantilever plate 30 can be connected to each other through the fixed plate 37. Accordingly, through the configuration that the supporting plate 36, the fixed plate 37, and the cantilever plate 30 are integrally formed as a one-piece structure, the assembling time of the stylus pen 1 can be effectively reduced. In some embodiments, the supporting plate 36, the fixed plate 37, and the cantilever plate 30 may be separated parts.

As shown in FIG. 3, in this embodiment, a bent sheet 47 is integrally connected between the first flexible sheet 45 and the second flexible sheet 46. Moreover, the first flexible sheet 45, the second flexible sheet 46, and the circuit board 60 may also be a one-piece structure. Therefore, before the assembling process, because of the one-piece configuration, the first flexible sheet 45, the second flexible sheet 46, and the circuit board 60 are already connected to each other, the assembling process can be achieved more easily. In some embodiments, the first flexible sheet 45, the second flexible sheet 46, and the bent sheet 47 may be separated parts.

In some embodiments, the connection position or the shape of the bent sheet 47 may be varied according to actual product demands, which will be described along with accompanying figures. As shown in FIG. 2 and FIG. 3, the first flexible sheet 45 has a first side 451, the second flexible sheet 46 has a second side 461, and the first side 451 and the second side 461 are adjacent to each other. The bent sheet 47 is integrally connected between the first side 451 and the second side 461 and covers a portion of the side portion 301 of the cantilever plate 30, and the length of the bent sheet 47 is equal to the length of the first side 451 and the length of the second side 461.

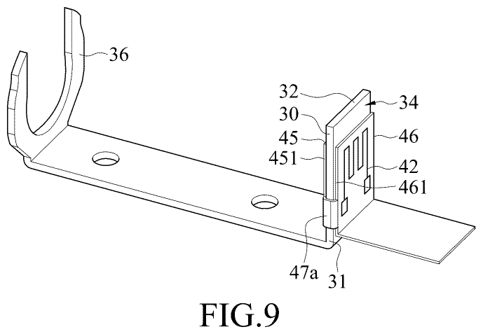

FIG. 9 illustrates a partial perspective view of a stylus pen according to a third embodiment of the instant disclosure. As shown in FIG. 9, in this embodiment, the bent sheet 47a is also integrally connected between the first side 451 of the first flexible sheet 45 and the second side 461 of the second flexible sheet 46. The difference between this embodiment and the embodiment shown in FIG. 3 lies in that, in this embodiment, the length of the bent sheet 47a is less than the length of the first side 451 and the length of the second side 461. Therefore, the stress generated in the bent sheet 47a during bending can be reduced, thereby facilitating the assembly of the first flexible sheet 45 and the second flexible sheet 46.

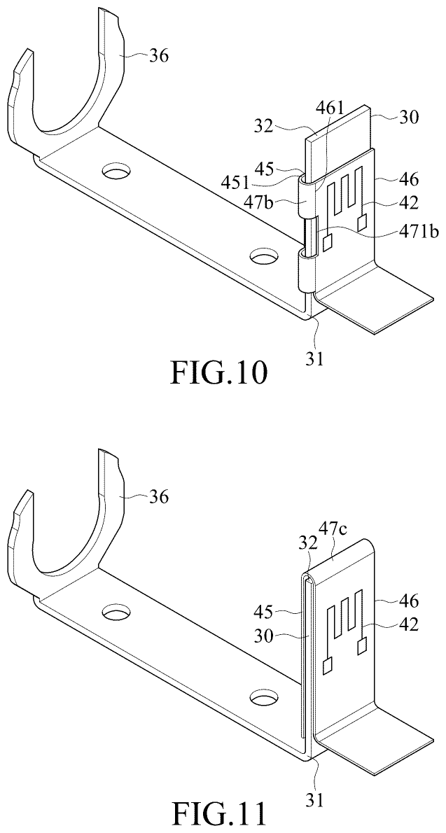

FIG. 10 illustrates a partial perspective view of a stylus pen according to a fourth embodiment of the instant disclosure. As shown in FIG. 10, in this embodiment, the bent sheet 47b is also integrally connected between the first side 451 of the first flexible sheet 45 and the second side 461 of the second flexible sheet 46. The difference between this embodiment and the embodiment shown in FIG. 3 lies in that, in this embodiment, the bent sheet 47b has at least one hollow portion 471b. Through the configuration of the hollow portion 471b, the stress generated in the bent sheet 47b during bending can be also reduced, thereby facilitating the assembly of the first flexible sheet 45 and the second flexible sheet 46.

FIG. 11 illustrates a partial perspective view of a stylus pen according to a fifth embodiment of the instant disclosure. As shown in FIG. 11, the difference between this embodiment and the embodiment shown in FIG. 3 lies in that, in this embodiment, the bent sheet 47c is integrally connected between the first flexible sheet 45 and the second flexible sheet 46 and is connected to side portions of the first flexible sheet 45 and the second flexible sheet 46 adjacent to the free side 32 of the cantilever plate 30, and the bent sheet 47c covers at least a portion of the free side 32 of the cantilever plate 30. Therefore, during the process of assembling the first flexible sheet 45 and the second flexible sheet 46 on the cantilever plate 30, the bent sheet 47c can be correspondingly placed on the free side 32 of the cantilever plate 30, so that the first flexible sheet 45 and the second flexible sheet 46 can be quickly positioned in advance to accelerate the assembling process.

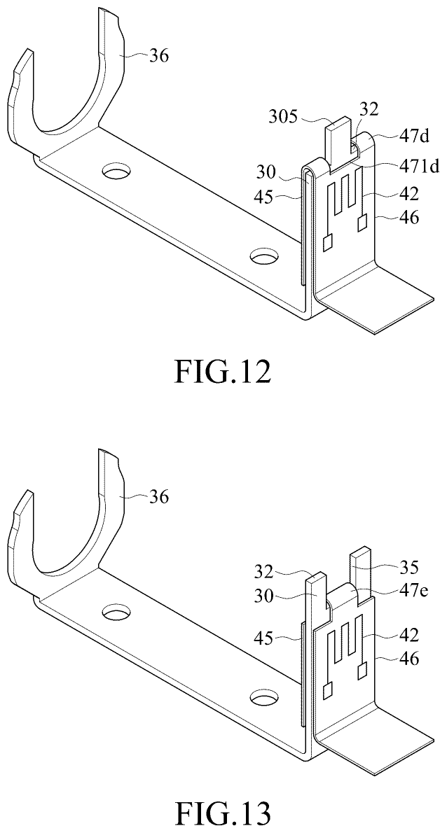

FIG. 12 illustrates a partial perspective view of a stylus pen according to a sixth embodiment of the instant disclosure. As shown in FIG. 12, the difference between this embodiment and the embodiment shown in FIG. 11 lies in that, in this embodiment, the bent sheet 47d has a hollow portion 471d, one side (in this embodiment, the free side 32) of the cantilever plate 30 has a protruding plate 305, and the protruding plate 305 penetrates into the hollow portion 471d of the bent sheet 47d, so that the first flexible sheet 45 and the second flexible sheet 46 can be positioned more properly during the assembling process.

FIG. 13 illustrates a partial perspective view of a stylus pen according to a seventh embodiment of the instant disclosure. As shown in FIG. 13, the difference between this embodiment and the embodiment shown in FIG. 11 lies in that, in this embodiment, one side (in this embodiment, the free side 32) of the cantilever plate 30 has a groove 35, and the bent sheet 47e is accommodated in the groove 35 of the cantilever plate 30. Therefore, likewise, the first flexible sheet 45 and the second flexible sheet 46 can be positioned more properly during the assembling process.

According to the stylus pen of one or some embodiments of the instant disclosure, the stylus pen has the first strain electrode and the second strain electrode, and the first strain electrode and the second strain electrode are respectively disposed on two opposite surfaces of the cantilever plate. As compared with the configuration that the strain electrode is only provided at one side of the cantilever plate, according to one or some embodiments of the instant disclosure, when the first strain electrode and the second strain electrode are deformed, a larger change in resistance difference can be generated, so that the sensing sensitivity can be enhanced. Moreover, because of the enhancement of the sensing sensitivity, the force the user applying to the stylus pen can be greatly reduced, so that the stylus pen of the instant disclosure can provide a better operation feeling.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A stylus pen comprising:
a hollow pen tube having an open end;
a pen head disposed at the open end;
a cantilever plate disposed in the hollow pen tube, wherein the cantilever plate has a fixed side, a free side, and a first surface and a second surface opposite to each other, the fixed side is fixed to the hollow pen tube, and the first surface faces the open end;
a first strain electrode disposed on the first surface of the cantilever plate; and
a second strain electrode disposed on the second surface of the cantilever plate;
wherein the pen head is selectively movable with respect to the hollow pen tube to deform the cantilever plate, thereby deforming the first strain electrode and the second strain electrode correspondingly.

2. The stylus pen according to claim 1, further comprising a linkage member, wherein the linkage member is movably disposed in the hollow pen tube, the linkage member has a first end and a second end which are opposite to each other, the first end is connected to the pen head, the second end has a protrusion, and the protrusion contacts the first surface of the cantilever plate and is adjacent to the free side.

3. The stylus pen according to claim 1, wherein when the first strain electrode and the second strain electrode are deformed, a resistance of one of the first strain electrode and the second strain electrode increases, and a resistance of the other one of the first strain electrode and the second strain electrode decreases.

4. The stylus pen according to claim 1, further comprising a circuit board, wherein the circuit board has a sensing circuit, the sensing circuit has a first fixed resistor and a second fixed resistor, the first strain electrode and the first fixed resistor are connected in series to form a first series connection circuit, the second strain electrode and the second fixed resistor are connected in series to form a second series connection circuit, and the first series connection circuit and the second series connection circuit are connected in parallel.

5. The stylus pen according to claim 1, further comprising a third strain electrode and a fourth strain electrode, wherein the third strain electrode and the fourth strain electrode are respectively disposed on the first surface and the second surface; when the cantilever plate is deformed, the third strain electrode and the fourth strain electrode are deformed correspondingly.

6. The stylus pen according to claim 5, wherein the first strain electrode and the fourth strain electrode are connected in series to form a first electrode group, the second strain electrode and the third strain electrode are connected in series to form a second electrode group, and the first electrode group and the second electrode group are connected in parallel.

7. The stylus pen according to claim 1, wherein the first surface of the cantilever plate is provided with a first flexible sheet, the second surface of the cantilever plate is provided with a second flexible sheet, the first strain electrode is on the first flexible sheet, and the second strain electrode is on the second flexible sheet.

8. The stylus pen according to claim 7, wherein a bent sheet is integrally connected between the first flexible sheet and the second flexible sheet.

9. The stylus pen according to claim 8, wherein one side of the cantilever plate has a groove, and the bent sheet is accommodated in the groove.

10. The stylus pen according to claim 8, wherein the bent sheet covers at least a portion of the free side of the cantilever plate.

11. The stylus pen according to claim 8, wherein the bent sheet has a hollow portion.

12. The stylus pen according to claim 11, wherein one side of the cantilever plate has a protruding plate, and the protruding plate penetrates into the hollow portion of the bent sheet.

13. The stylus pen according to claim 1, further comprising a linkage member, wherein the linkage member is movably disposed in the hollow pen tube and between the pen head and the cantilever plate, the linkage member has a first end and a second end which are opposite to each other, the first end is connected to the pen head, and the second end contacts the first surface of the cantilever plate.

14. The stylus pen according to claim 13, further comprising a supporting plate, wherein the supporting plate is disposed in the hollow pen tube, and the supporting plate is connected to the linkage member and adjacent to the first end of the linkage member connected to the pen head.

15. The stylus pen according to claim 14, wherein the supporting plate is connected to the cantilever plate.
